(19) United States
(12) Patent Application Publication
(10) Pub. No.: US 2005/0042034 A1
(43) Pub. Date: Feb. 24, 2005

(54) Pipeline trench system and method of encasing for spill containment

(75) Inventors: Jon R. Bose, Houston, TX (US); C. Lee Sherrod, Austin, TX (US); Allan W. Wolff, Tulsa, OK (US); Charles Kreitler, Austin, TX (US); Mark S. Gerding, Houston, TX (US); Richard Hoyle, Tulsa, OK (US); Pat Rice, Tulsa, OK (US); Tommy Douglas, Houston, TX (US); Bryce Harrell, Converse, TX (US); James Beach, Austin, TX (US)

Correspondence Address: JENKENS & GILCHRIST, PC, 1445 ROSS AVENUE, SUITE 3200, DALLAS, TX, 75202, US

(73) Assignee: Longhorn Partners Pipeline, LP, Dallas, TX (US)

(21) Appl. No.: 10/810,010

(22) Filed: Mar. 25, 2004

Related U.S. Application Data
(63) Continuation-in-part of application No. 10/703,861, filed on Nov. 6, 2003.
(60) Provisional application No. 60/458,247, filed on Mar. 27, 2003.

(51) Int. Cl. G21F 5/00; B65D 90/24

(52) U.S. Cl. 405/129.57; 405/129.5

(57) ABSTRACT

A pipeline trench system may include a spill containment pipe with a pipeline disposed therein. The pipeline may be surrounded by a centralizer ring and the system may further include a leak detection system.

### CROSS-REFERENCES TO RELATED APPLICATIONS

This application claims priority from, and incorporates by reference for any purpose, the entire disclosure of U.S. Provisional Patent Application No. 60/458,247 filed Mar. 27, 2003. This application is a Continuation-In-Part of, and incorporates by reference for any purpose the entire disclosure of, U.S. patent application Ser. No. 10/703,861 filed Nov. 6, 2003 which claims priority from U.S. Provisional Patent Application No. 60/424,674, filed Nov. 7, 2002.

### BACKGROUND OF THE INVENTION

1. Field of the Invention

The present invention relates to pipeline trench systems, and more particularly, but not by way of limitation, to a pipeline trench system and method of encasing a carrier pipe within an outer spill containment pipe capable of containing fluid leaking from the carrier pipe disposed therein for subsequent collection of leaking fluid therefrom.

2. History of Related Art

The public relations problems associated with pipelines constructed to carry hydrocarbons across any appreciable distance is well known to government, industry, and the general public. More significant concern arises when pipelines extend across environmentally sensitive and/or populated areas. It has been found that if a pipeline, carrying hydrocarbons or other liquids, develops a leak allowing seepage of the hydrocarbons or other liquids into the surrounding area, the environment may be adversely affected. For example, a pipeline leak, that is not appropriately contained, can result in surface flows or groundwater flows carrying the polluting hydrocarbons to an underground water supply. Not only is the water supply tainted, but wildlife associated with either the groundwater or underground water supply may suffer from effects caused by the release of the hydrocarbons.

The perceived environmental impact from a leak of hazardous liquids over a sensitive environmental area, such as an aquifer recharge region, may in some cases potentially be contamination of the aquifer. This could cause significant environmental impacts for the users of the aquifer, which may, in some cases, number in the hundreds of thousands of people in multiple cities and towns. For these reasons, modern improvements in pipeline reliability are not always “perceived as” or “deemed” sufficient. The present invention thus relates to a spill containment and system and method minimizing the exposure of the surrounding area to liquids such as hydrocarbons that may harm the environment.

### SUMMARY OF THE INVENTION

The present invention relates to pipeline trench systems and methods of construction. More particularly, one aspect of the invention includes a spill containment pipe system comprising a spill containment pipe for capturing a leak from a pipeline surrounded by the spill containment pipe, a leak detection system for determining if a leak from the pipeline has occurred, a centralizer ring for preventing the pipeline from directly contacting the spill containment pipe, and a galvanic anode ribbon for aiding in cathodic protection of the spill containment pipe system.

In another aspect, the present invention relates to a pipeline protection system for preventing fluid from leaking from a pipeline to the surrounding environment. The system comprises a spill containment pipe for capturing leaked fluid from the pipeline surrounded by the spill containment pipe, and a storage area, such as a bore pit, in select flow communication with the spill containment pipe. The bore pit receives an amount of leaked fluid captured by the spill containment pipe and directed to the bore pit.

In another aspect, the present invention relates to a method of creating a containment system adapted for containing at least a predetermined volume of fluid released from a pipeline disposed therein. The method comprises the steps of excavating a trench in a ground area for housing at least a portion of the containment system, positioning a centralizer ring around the pipeline, placing a leak detection system for determining if a leak from the pipeline has occurred, placing a galvanic anode ribbon substantially contacting the pipeline for aiding in cathodic protection, encasing the pipeline with a spill containment pipe for capturing a leak from a pipeline, and placing the encased pipeline within the excavated trench.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a side elevational view of the sealed trench design that may be used in conjunction with the present invention;

FIG. 2 is an end elevational view of the sealed trench construction of FIG. 1 illustrating further aspects of construction of the sealed trench design, and in particular the walls and floor;

FIG. 2A is a detailed view of a lower corner of the trench construction of FIG. 2;

FIG. 2B is a detailed view of an upper corner of the trench construction of FIG. 2;

FIG. 3 is a side elevational schematic representation of a length of pipeline utilizing a bore pit and a profile thereof;

FIG. 4 is an end view of the bore pit and trench system shown in FIG. 3;

FIG. 5 is a top view of the bore pit and trench system shown in FIG. 3;

FIG. 6 is a top view of the bore pit and trench system in accordance with an embodiment of the present invention;

FIG. 7 is a cross-sectional view of a spill containment pipe and pipeline in accordance with an aspect of the present invention;

FIG. 8 is a side elevational view of a connection between the spill containment pipe and a steel pipe;

FIG. 9 is a side elevational view of a connection between two spill containment pipes; and

FIG. 10 is a perspective view of the spill containment pipe.

### DETAILED DESCRIPTION

It has been found that the trench system including a spill containment pipeline of the present invention can minimize exposure of the earthen region below and above a pipeline to pipeline spills. In that regard, the present invention includes several aspects. The pipeline may, in some instances, be encased in a pipeline trench comprising an elongate sealed vault as shown in U.S. patent application Ser. No. 10/703,861 (hereinafter the parent application) to prevent leakage into the surrounding area. In applications where the sealed vault is not practicable, a spill containment pipe, such as a High-Density Polyethylene (HDPE), may be used to encase the pipeline. The spill containment pipe contains spillage and routes the leaking fluid to another area, i.e., a bore pit. The bore pits (typically on the order of eight feet wide and 25-30 feet deep as shown in certain embodiments) are located at specific areas along the pipeline in flow communication with the pipeline trench for containing large amounts of leakage flowing from either the pipeline trench of the spill containment pipe. For instance, if a leak occurs along the pipeline, the leaking fluid flows into the sealed vault or the spill containment pipe. The sealed vault acts as a conduit to direct the fluid to the lowest elevation area (e.g., a bore pit). The bore pit is capable of containing a relatively large amount of leakage relative to the same length of the sealed vault.

Depending on the topology and geology of the surrounding area, subsurface containment, such as a bore pit, may not be an optimal solution. As such, an above-ground containment area may also be used. In an above-ground containment implementation, berms or diked areas are utilized to contain spillage into specified areas. Therefore, any leakage from the pipeline fills the sealed vault, and when the sealed vault can no longer contain the spill, the fluid percolates up to the surface. The fluid at the surface is directed and pooled by the berms to prevent seepage into the surrounding area. Above-ground containment areas work well in rolling terrain where gravity assists the pooling and flow of fluids. A variety of arrangements of the sealed vault, bore pits, and above-ground containment area may be utilized to suit the terrain including flow valves for allowing the flow of water from the berms but not the flow of select fluids such as those containing hydrocarbons which can damage the environment.

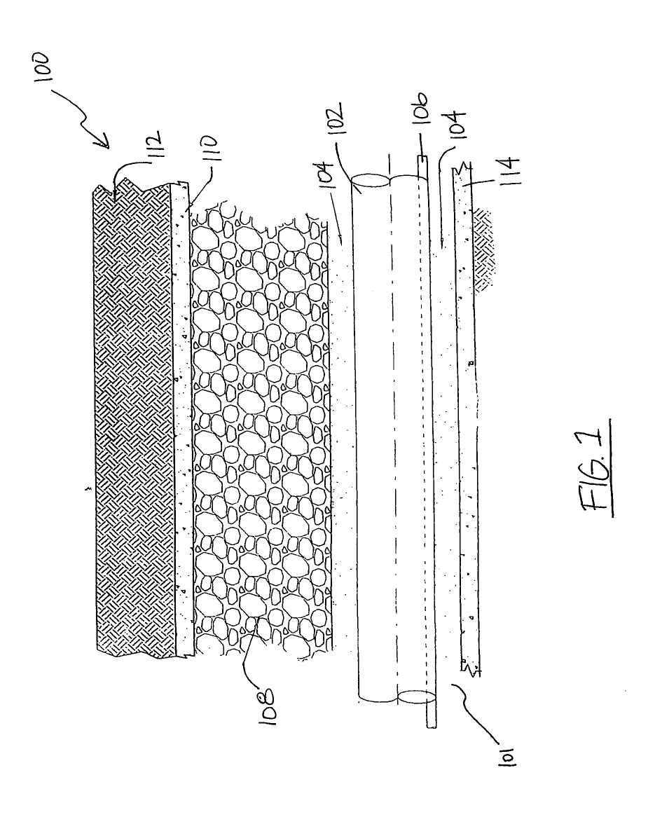

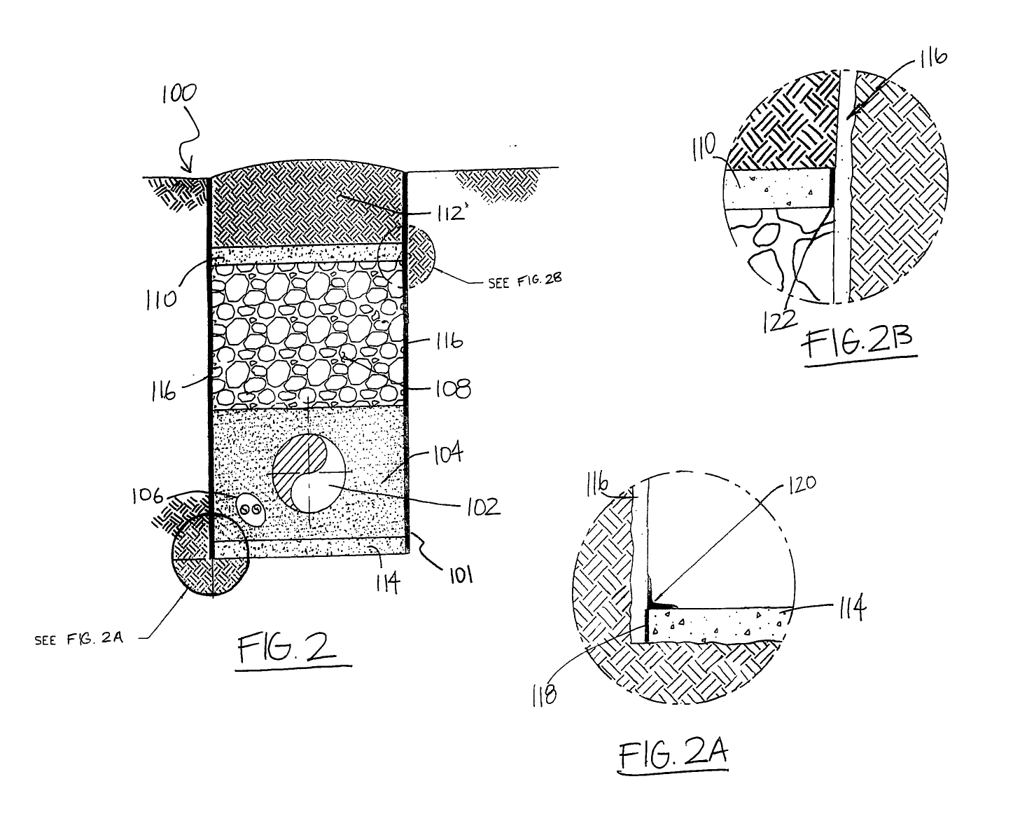

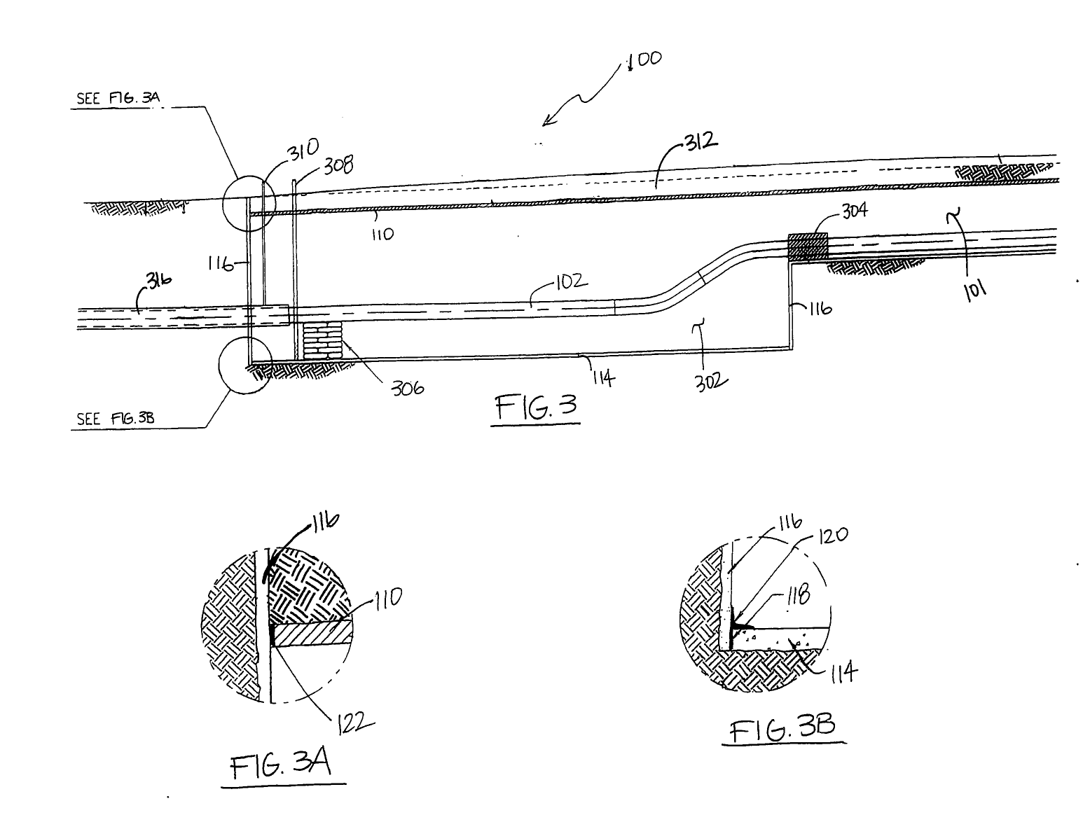

Referring now to the drawings, FIG. 1 illustrates a side elevational view of the trench system 100 that may be used in conjunction with embodiments of the present invention. A sealed vault 101 of the trench system 100 is on the order of four feet wide and eight feet deep, however, other sizes of trench systems 100 may be implemented depending on the topography and geology of the surrounding area and the size of the pipeline 102. The construction aspects include a select bedding 104 disposed beneath the pipeline 102, a leak detection conduit 106 adjacent the pipeline 102 (seen more clearly in FIG. 2), select bedding 104 above the pipeline 102, and select backfill 108 atop the bedding 104 atop the pipeline 102. The leak detection conduit 106 provides a means of placing a sensing cable capable of direct detection of a hydrocarbon material via direct contact of the cable by any leaked hydrocarbon substance in the sealed vault 101. At various intervals along the pipeline 102, a junction box may be placed at or near ground level above the pipeline 102. The junction box provides means for monitoring and/or testing, and/or replacement of the leak detection cables and circuits. A power conduit and a sensor conduit exit the junction box and travel down to the pipeline 102. The sensor conduit and the power conduit may be adjacent the pipeline 102 for sensing released hydrocarbons by direct contact. The conduits may be made of simple polyvinyl chloride (PVC) pipe. The power conduit is a solid wall design and the sensor conduit is made of “well screen” pipe, i.e., the pipe has minute slots cut into it to allow liquid to contact the leak detecting cable, but the slots are fine enough to keep sand and gravel out of the conduit. Tyco Thermal Controls of Menlo Park, Calif. manufactures conduit that is suitable for the power conduit and the sensor conduit.

Cathodic protection by impressed current relies on current from an outside power source being impressed on the pipeline 102 by using a ground bed and a power source to prevent galvanic corrosion of the pipeline 102 by moisture and electrolytes in the earth or soils around the pipeline 102. The backfill 108 and bedding 104 contain sufficient latent amounts of moisture as to aid the required current conduction path in order for the cathodic protection system to perform as required. Metal is not used to form the trench system 100 or sealed vault 101 in order to allow the impressed current to pass through the sealed vault 101. Although impressed current may be used for providing cathodic protection, other methods or systems of cathodic protection may be utilized.

The backfill 108 and bedding 104 are selected and graded to provide a high permeability fill with an interstitial void space capable of liquid capture and containment. The bedding 104 includes pea-size gravel and the select backfill 108 includes crushed and graded limestone with a porosity of the backfill interstitial space exceeding 40%. An upper barrier 110, typically made of concrete, is placed thereover, and the remaining portion of the trench is filled with compacted backfill forming a ditch crown 112. The backfill utilized in forming the ditch crown 112 is typically low permeability material which serves to inhibit the infiltration of rainwater into the trench system 100. The ditch crown 112 is shaped to prevent the rainwater from accumulating in the vicinity of the trench system 100.

The upper barrier 110 is four inches thick and dyed red, however, other thicknesses and dyes may be used. The upper barrier 110 is dyed red in order to alert third parties that might excavate in the pipeline right-of-way to the presence of a manmade structure below. In addition to the upper barrier 110, a lower barrier 114, also typically of concrete, provides an impermeable floor to prevent liquids transported through the pipeline 102 from leaking into an area below the pipeline 102.

Referring now to FIG. 2, there is shown an end elevational view of the sealed vault 101 of FIG. 1 illustrating further aspects of construction of the trench system 100. The side walls 116, the lower barrier 114, and the upper barrier 110 are sealed to form the sealed vault 110 that houses the pipeline 102. The trench is excavated and any features (e.g., fissures, voids, etc.) along the side walls are identified for possible attention. When necessary, the features are filled to reduce the likelihood that leakage from the pipeline 102 may permeate the side walls 116 and enter any such feature. By sealing the features, a high degree of sealing protection is achieved in the trench.

For example, in some geographies, varying degrees of secondary dissolution form a honeycomb or vugular porosity in a somewhat random pattern throughout the strata, thereby potentially penetrating side and bottom portions of the trench. The vugular porosity often functions as a recharge feature that carries groundwater eventually feeding an aquifer or other body of water. Therefore, it may be necessary to seal all such features to prevent any leakage from mixing with groundwater. Large features of the trench are filled with rock and spot cemented prior to applying shotcrete to the side walls 116 in order to provide a fluid seal and a firm foundation for the adhesion of the shotcrete. The features in the trench may also be sealed or filled by utilizing grout, gravel, cobbles, etc. depending upon the size, configuration and orientation of the void or fissure. In addition, various other pipelines, such as storm drains, may cross the path of the pipeline 102 and sealed vault 101. In these cases, the joints of the storm drain are grouted and the exterior of the storm drain is sealed with shotcrete.

The side walls 116 are formed of shotcrete which adheres to the sides of the trench. Shotcrete is a mixture of aggregate, cement, glass fibers, and water with other additives that is sprayed into place under pressure with a select quantity of moisture in the mixture. This application allows the shotcrete to be sprayed on the side walls 116 rather than poured in place using forms. The shotcrete may be applied as a wet mix or a dry mix. The dry mix system transfers a dry mix of aggregate and cement through a hose where water is added at the nozzle. The wet mix system pumps a low slump concrete through a hose where air is added at the nozzle. The dry mix system is commonly known as “gunite”. To increase the strength of the side walls 116, the shotcrete mixture may be applied with a relatively low moisture content via the dry mix system, although the wet mix system may be used in addition to or in lieu of the dry mix system. The side walls 116 are formed prior to the lower barrier 114 in order to facilitate the sealing between the side walls 116 and the lower barrier 114.

As seen more clearly in FIG. 2A, the lower barrier 114 is disposed against the shotcrete-coated side walls 116 of the trench system 100 with a bonding agent 118 disposed therebetween. The bonding agent 118 is placed on the side walls 116 to further facilitate the bonding between the lower barrier 114 and the side walls 116. The bonding agent 118 may be an epoxy adhesive capable of accommodating movement within the trench. For example, a bonding agent such as “Sikadur 32 Hi Mod” has been found to be effective.

To effect further sealing integrity of the trench, a spray-applied polyurethane joint seal 120 is disposed along the side walls 116 and lower barrier 114 of the trench, after installation of the lower barrier 114, particularly along both side walls 116 extending outwardly therealong. The joint seal 120 may be sprayed anywhere along the length of the side walls 116, however, the majority of the joint seal 120 may be sprayed in the lower corners of the trench system 100 and feathered out onto the side walls 116 and the lower barrier 114 about ten inches. At the joint of the side walls 116 and lower barrier 114, the thickness of the joint seal 120 is approximately between the range of 90 to 125 mils, i.e., 1 mil=1/1000^{th} of an inch, however other thicknesses may be utilized. The joint seal 120 is feathered out to a thickness in the range of 40 to 90 mils on the side walls 116 and the lower barrier 114. By feathering out the joint seal 120 and varying the thickness, a durable seal with high adhesion is obtained. If the trench system 100 ever were to experience movement due to settling and shifting of the surrounding area, when utilizing the feathering technique, the joint seal 120 maintains adhesion to the concrete during movement without pulling loose from the side walls 116 and the lower barrier 114.

As shown in more detail in FIG. 2B, to seal the upper portion of the trench system 100, in some instances the upper barrier 112 is bonded to the side walls 116 of the trench system 100 with a bonding agent 122. For example, sealing the upper portion or the trench system 100 may prove valuable on approach to bore pits to prevent upward percolation of leakage from the pipeline trench. The bonding agent 122 may be similar to the bonding agent 118 applied at the lower portion of the side walls 116. After the lower portion of the sealed vault 101 has been properly sealed, backfill 108 is loaded into the sealed vault 101 to a predetermined height and the bonding agent 122 is applied to the side walls 116. The upper barrier 110 is then poured and adheres to the side walls 116 to prevent seepage of rainwater into the sealed vault 101 as well as seepage of fluid from the pipeline 102 into the surrounding area. The use of a bonding agent 122 in this location may vary in different parts of the trench system 100 as the likelihood of hydrostatic pressure from fluid collection varies.

As previously described, it is not necessary for all locations to include an upper barrier 110. In some areas an above-ground containment region may be desired, in which case an upper barrier 110 would not exist. In the above-ground containment region, the upper barrier 110 is not formed so that leaking fluid may flow to the surface for above-ground containment and later recovery.

Referring now to FIG. 3, there is shown a trench system 100 including a bore pit 302 which may be utilized in the construction of the trench system 100. Bore pits 302 may include backfill, however, the backfill is eliminated in FIG. 3 for clarity. In certain instances, the elevation of the pipeline 102 is varied to accommodate geographical aspects, such as roads and the like. When utilized for crossing under a roadway, railway, or similar feature, a steel casing pipe may be utilized to facilitate installing the pipeline 102 under the roadway. As previously mentioned, bore pits 302 are utilized to construct a bore for extending the pipeline at locations where surface excavation is impractical or undesirable. In some instances the bore pits 302 may be on the order of 25-30 feet deep, however, other depths may be utilized depending on the terrain encountered. The bore pit 302 may be sealed off by a partial or full trench plug 304. The trench plug 304, whether partial or full, is typically formed of cement, however, other materials that are not substantially permeable to liquid may be utilized. The trench plug 304 prevents pipeline 102 fluid from leaking to other areas. The bore pit 302 also provides a region adapted for accumulation of any pipeline spill that may occur. The bore pit 302 may be filled with backfill or bedding in a manner similar to that of the sealed vault 101 shown in FIGS. 1 and 2. The bore pit 302 may house one or more supports 306 to bolster up the pipeline 102. A drain pipe 308 and a vent pipe 310 may also be included in the trench system 100. The drain pipe 308 provides a means for inspection and removal of fluid. The vent pipe 310 is attached to each end of the casing pipe 316 below a road bore. One utility of the vent pipe 316 is to allow monitoring of the interstitial space between the pipeline 102 and the casing pipe 316 for the presence of a leaked select fluid or water.

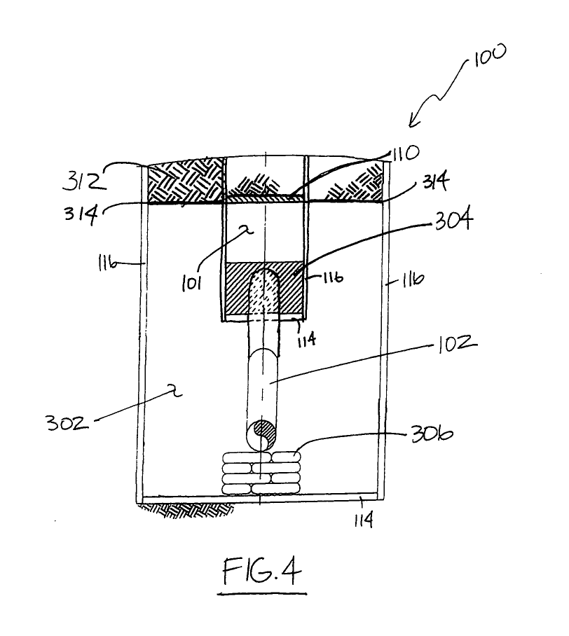

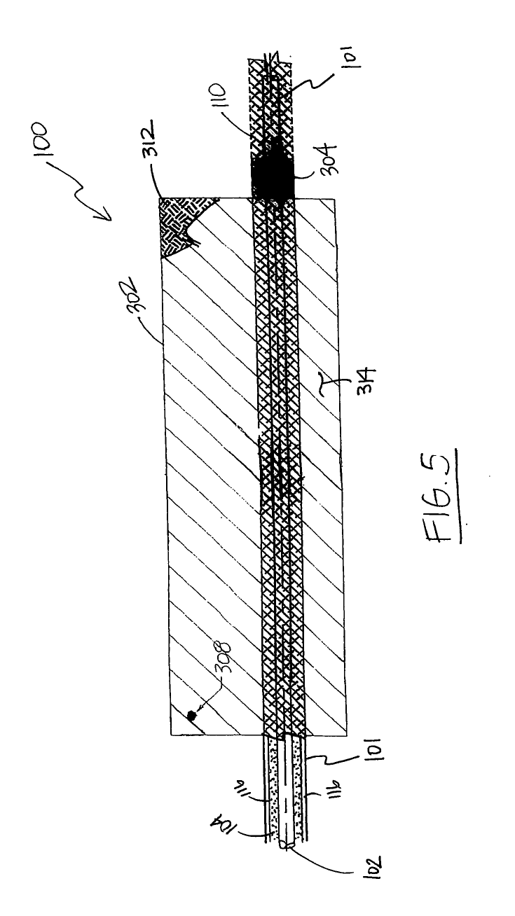

The upper barrier 110 may not extend the entire width of the bore pit 302 (shown in FIG. 4). A layer of top soil 312 may form a barrier that, due to appropriate packing and/or grading, will divert and/or absorb water in order to inhibit substantial infiltration of the water into the bore pit 302, which is filled with backfill, as described herein.

As illustrated in FIGS. 3A and 3B, the side walls 116, lower barrier 114, and upper barrier 110 may be sealed as set forth above with respect to FIGS. 2A and 2B. The bore pit 302 includes a partial upper barrier 110 for preventing third party damage. However, it is possible to utilize a bore pit 302 without an upper barrier 110 so that the fluid flows into an above-ground containment area.

FIGS. 4 illustrates an end view of the bore pit 302 and trench system 100. As shown, the sealed vault 101 includes an upper barrier 110 and a lower barrier 114. The sealed vault 101 is also partially sealed from the bore pit 302 with the trench plug 304. The pipeline 102 leaves the sealed vault 101 and descends into the bore pit 302. The pipeline 102 is supported by supports 306 and the interior of the bore pit 302 may be filled with bedding and backfill (not shown). The sealed vault 101 is topped with a ditch crown 112 for preventing rainwater from pooling above the trench system 100. The bore pit 302 may not include an upper barrier 110 that extends the entire width of the bore pit 302. Instead, a geotextile cloth 314 may be placed over the backfill and top soil 312 is positioned on the geotextile cloth 314. The geotextile cloth 314 prevents the top soil 312 from migrating into the backfill and reducing the capacity of the bore pit 302. As previously mentioned, the top soil 312 is disposed to absorb water or is packed sufficiently to prevent substantial amounts of water from infiltrating into the bore pit 302.

FIG. 5 illustrates a top plan view of the bore pit 302 and the construction thereof. The pipeline 102 travels through a sealed vault 101, into a bore pit 302, and to a second sealed vault 101. As shown, the upper barrier 110 spans the entire width of the sealed vaults 101, but does not span the entire width of the bore pit 302. The geotextile cloth 314 and the top soil 312 are implemented for reducing the infiltration of water into the bore pit 302. Fluid leaking from the pipeline 102 housed within the sealed vault 101 may flow into the bore pit 302 for containment. The drain pipe 308 is utilized to monitor the fluid level and may also be used to remove the leaking fluid or groundwater that has seeped into the bore pit 302. The trench plug 304 creates a seal that prevents leakage flowing into the bore pit 302 from traveling further down the trench system 100 into, for example, another sealed vault 101.

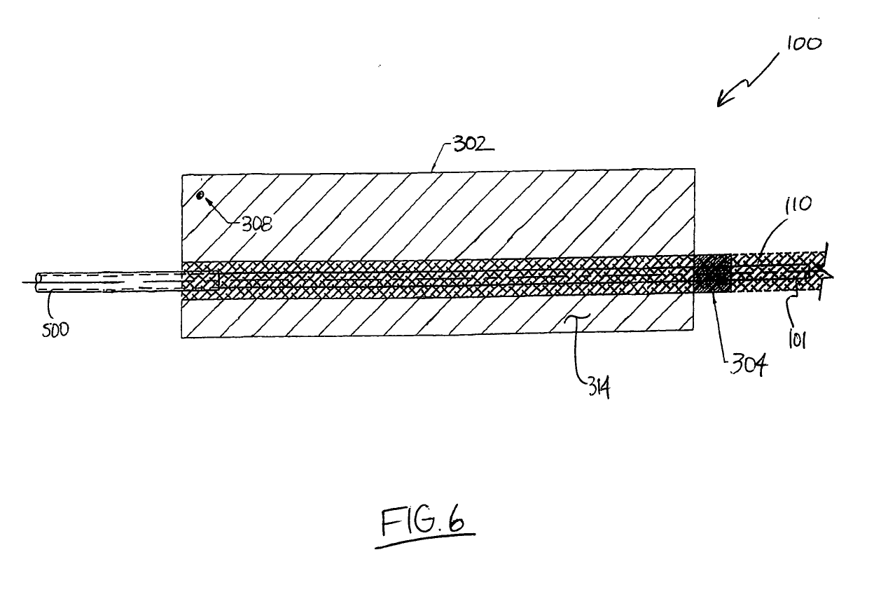

Referring now to FIG. 6, a top view of the bore pit and trench system in accordance with an embodiment of the present invention is illustrated. As previously shown in FIG. 5, the pipeline 102 travels through a sealed vault 101 and into a bore pit 302. In this embodiment, instead of flowing into another sealed vault, when the pipeline 102 exits the bore pit 302, the pipeline 102 is surrounded by an outer spill containment pipe 500. The outer spill containment pipe 500 may be formed of HDPE or other material with similar characteristics.

In the preferred embodiment, the outer spill containment pipe 500 is formed of HDPE having a pressure rating of 50 pounds per square inch gage (“psig”) in continuous hydrocarbon service and 100 psig in water service. The manufacturer estimates burst pressure for the outer spill containment pipe 500 (a) in the case of a slow pressurization at 500 psig, and (b) in the case of a rapid pressurization in excess of 360 psig. The outer spill containment pipe 500 end seals are rated for approximately 20 psig. In the event of a release, the fluid leaving the pipeline 102 would enter the outer spill containment pipe 500 at atmospheric pressure. As the release volume increased within the outer spill containment pipe 500, the pressure would build briefly until the pressure reached approximately 20 psig, when the end seal would be displaced and allow the release to flow into the containment area. The outer spill containment pipe 500 also possesses the flexibility to conform to the contours of the steel carrier pipe across uneven terrain.

The upper barrier 110 does not span the entire width of the bore pit 302 and the upper barrier terminates at the end of the bore pit 302. The geotextile cloth 314 and the top soil 312 are implemented for reducing the infiltration of water into the bore pit 302. Fluid leaking from the pipeline 102 housed within the outer spill containment pipe 500 may flow into the bore pit 302 or another location for containment. The drain pipe 308 is utilized to monitor the fluid level and may also be used to remove the leaking fluid or groundwater that has seeped into the bore pit 302. The trench plug 304 creates a seal that prevents leakage flowing into the bore pit 302 from traveling further down the trench system 100 into, for example, another sealed vault 101.

The outer spill containment pipe 500 may be employed when the use of the permeable trench backfill is not beneficial. For example, the benefits of the permeable trench backfill are negated in the presence of perennial groundwater which would keep the backfill saturated and reduce or eliminate its ability to contain a product release. Therefore, to prevent product leakage, the outer spill containment pipe 500 surrounds the pipeline 102 and conducts any release from the affected area to a containment area not affected by perennial groundwater. The containment area may be a bore pit 302, bermed or diked area, etc. In addition, the outer spill containment pipe 500 accommodates leak detection conduits without hindering their effectiveness.

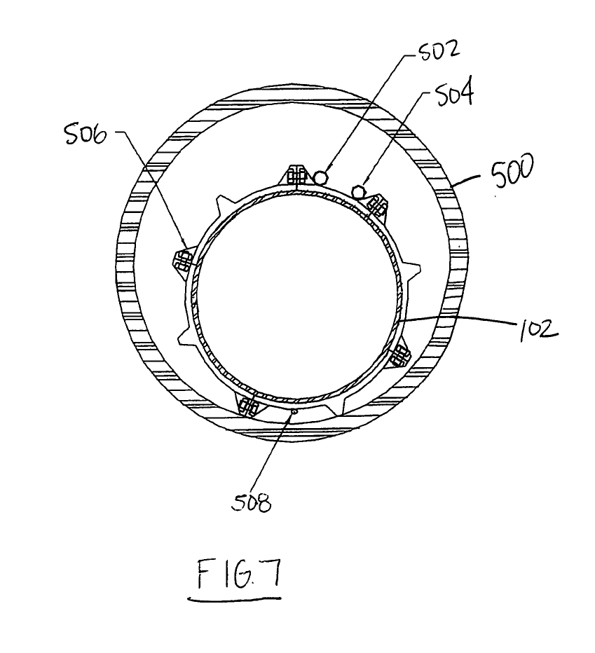

Referring now to FIG. 7, a cross-sectional view of a spill containment pipe and pipeline in accordance with an aspect of the present invention is illustrated. Since the pipeline 102 is typically lifted by heavy equipment utilizing lifting straps while assembling the casing segments, a leak detection power conduit 502 and a leak detection well screen conduit 504 are, in the preferred embodiment, located near the top of the pipe (between the 10:00 and 2:00 o'clock positions) to avoid crushing the conduits 502, 504 with the lifting tackle. Although the preferred embodiment positions the conduits 502, 504 near the top of the pipeline 102, it is within the scope of the present invention to place the conduits 502, 504 anywhere along the pipeline 102, including a lower portion of the pipeline 102.

Installed on an outer surface of the pipeline 102 is a centralizer ring 506. The centralizer ring 506, in the preferred embodiment, is formed as a bolt-on ring, although other means of securement may be used. The centralizer ring 506 prevents the pipeline 102 from resting directly against the outer spill containment pipe 500. Along an outer surface of the centralizer ring 506 and/or the pipeline 102 is a galvanic anode ribbon 508 formed of zinc or magnesium for cathodic protection. Although the outer spill containment pipe 500 is designed to remain dry within the interior, the galvanic anode ribbon 508 provides protection should moisture infiltrate the interior of the outer spill containment pipe 500. The galvanic anode ribbon 508 includes lead wire connections that terminate above ground at junction boxes. The junction boxes allow fluid levels within the outer spill containment pipe 500 to be monitored. Copper sulfate reference half-cells may be installed within the outer spill containment pipe 500 to provide a means for reading cathodic protection potentials that are monitored through cathodic protection test stations associated with the cathodic protection system. In this manner the pipeline 102 segments within the outer spill containment pipe 500 are protected from potential corrosion.

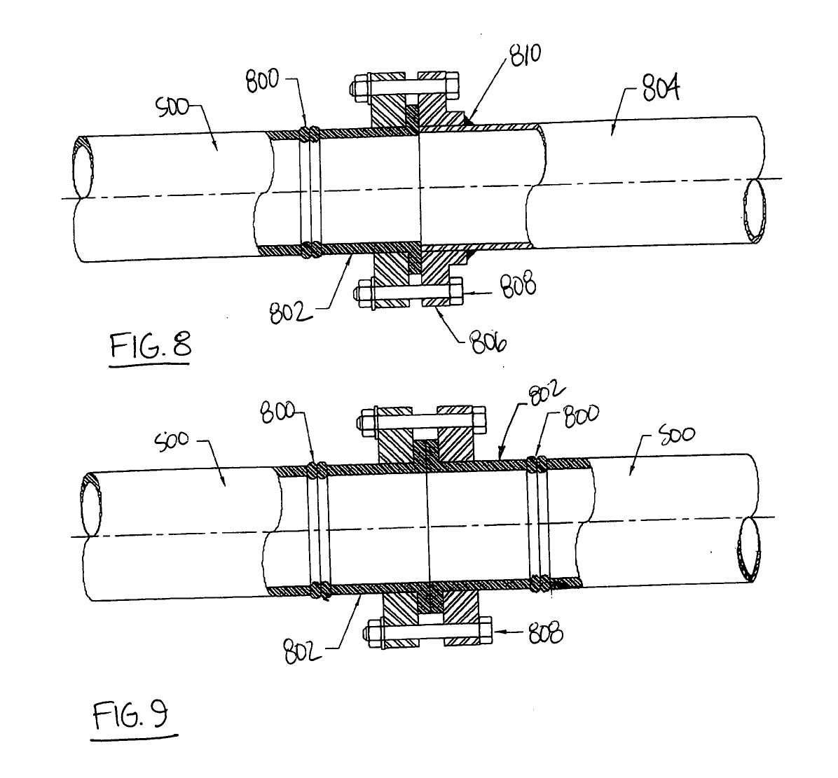

Referring now to FIG. 8, a side elevational view of a connection between the spill containment pipe and a steel pipe is illustrated. The outer spill containment pipe 500 may be formed in a variety of lengths, such as 50-foot sections, that may be joined together by fusion welding or flange connections. These welds are considered to be as strong or stronger than the base material. The flange connections may be of a lap joint configuration utilizing formed stub ends coupled with flange rings. In the preferred embodiment, the stub ends may be formed of HDPE and the flange rings may be formed of steel.

As illustrated in FIG. 8, the outer spill containment pipe 500 may be fused, at a butt fusion joint 800, to a flange adaptor or stub end 802. The stub end 802 is connected, via a flange connection, to a steel pipe 804. The flange connection is provided by the stub end 802, a steel flange 806, and a connector 808. In the preferred embodiment, the connector 808 is a nut, washer, and bolt, however other means of connection are possible. The steel flange 806 is connected to the steel pipe 804 by a weld 810.

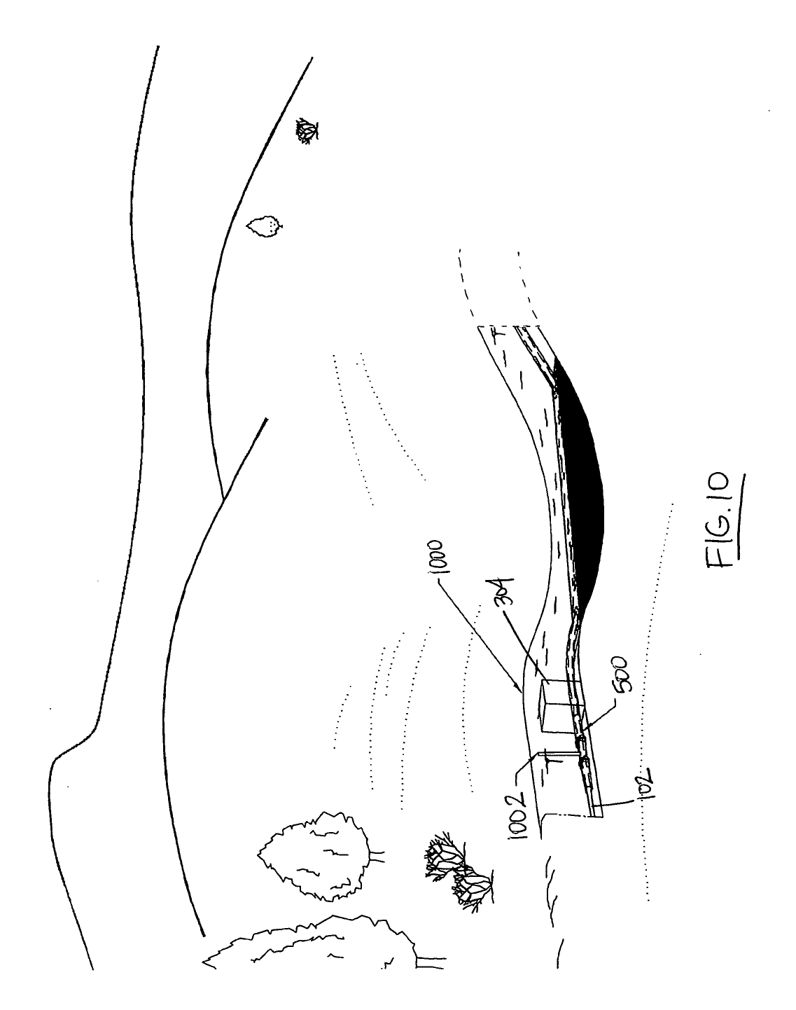

Referring now to FIG. 9, a side elevational view of a connection between two spill containment pipes 500 is illustrated. A first spill containment pipe 500 is fused to a stub end 802 at a butt fusion joint 800 in a manner similar to that set forth in FIG. 8. The stub end 802 is connected to another stub end 802 of another section of a spill containment pipe 500 at a flange connection. The flange connection is secured by a connector 808 in a manner similar to that of FIG. 8.

Referring now to FIG. 10, a perspective view of the spill containment pipe is illustrated. A trench 1000 houses the pipeline 102 and surrounding spill containment pipe 500. At various locations a trench plug 304 may be utilized to prevent flow of leaked product to specific locations. One or more risers 1002 may be provided, at some locations, in flow communication with the spill containment pipe 500. The risers 1002 form, in one embodiment, tubular members which upstand from the spill containment pipe 500 for facilitating the testing of the environment around the pipeline 102, and within the spill containment pipe 500. The risers 1002 also allow for the extraction of liquids, such as water, if any should infiltrate the spill containment pipe 500 and hydrocarbons if any should leak from the pipeline 102 in the event of a release incident. A plurality of risers 1002 may be utilized in accordance with the principles of the present invention.

One skilled in the art would understand that aspects of the present invention need not be implemented throughout the entire run of the pipeline 102, from one endpoint to another. For example, many portions of an area through which the pipeline 102 passes may not require a sealed vault 101 or outer spill containment pipe 500 due to the fact that the soils of the surrounding area may be relatively impermeable to liquid. Therefore, it is not necessary for the side walls 116 and lower barrier 114 of the sealed vault 101 to be coated with shotcrete and/or cement. Furthermore, one skilled in the art would readily appreciate that although the preferred embodiment illustrates side walls 116 and a lower barrier 114 that are substantially orthogonal, any configuration of trench and walls may be implemented without departing from the spirit and scope of the present invention.

The previous description is of a preferred embodiment for implementing the invention, and the scope of the invention should not necessarily be limited by this description. The scope of the present invention is instead defined by the following claims.

1. A spill containment pipe system comprising:
a spill containment pipe for capturing a leak from a pipeline surrounded by the spill containment pipe;
a leak detection system for determining if a leak from the pipeline has occurred;
a centralizer ring for preventing the pipeline from directly contacting the spill containment pipe; and
a galvanic anode ribbon for aiding in cathodic protection of the spill containment pipe system.

2. The system of claim 1, wherein the leak detection system comprises:
a leak detection power conduit for providing power to the leak detection system.

3. The system of claim 1, wherein the spill containment pipe is formed of High Density Polyethylene (HDPE).

4. The system of claim 1, wherein the galvanic anode ribbon is formed of zinc.

5. The system of claim 1, wherein the galvanic anode ribbon is formed of magnesium.

6. The system of claim 1, further comprising:
a plurality of junction boxes for monitoring a level of fluid within the spill containment pipe.

7. The system of claim 1, further comprising:
a plurality of copper sulfate reference half-cells for providing cathodic protection potentials.

8. The system of claim 1, wherein the spill containment pipe is formed in fifty foot lengths.

9. The system of claim 1, wherein the spill containment pipe is formed with a diameter of thirty inches.

10. The system of claim 1, further comprising:
at least one flange adaptor fused to the spill containment pipe for connecting with a second section of spill containment pipe or a steel casing pipe.

11. The system of claim 10, further comprising:
a steel flange for connecting the flange adaptor to the steel casing pipe or the second section of spill containment pipe.

12. The system of claim 1, further comprising:
at least one riser for facilitating testing of an environment surrounding the pipeline and within the spill containment pipe.

13. A pipeline protection system for preventing fluid from leaking from a pipeline to the surrounding environment, the system comprising:
a spill containment pipe for capturing leaked fluid from the pipeline surrounded by the spill containment pipe; and
a bore pit in select flow communication with the spill containment pipe, the bore pit for receiving an amount of leaked fluid captured by the spill containment pipe and directed to the bore pit.

14. The system of claim 13, wherein the bore pit includes an enlarged trench area in flow communication for containing fluid from the pipeline in a subsurface arrangement.

15. The system of claim 13, wherein the bore pit comprises:
substantially vertical side walls, the side walls being formed of a substantially fluid impervious material;
a lower barrier in engagement with the side walls, the lower barrier being formed of a substantially fluid impervious material; and
a first bonding agent adapted for bonding the vertical side walls to the lower barrier.

16. The system of claim 15, wherein the first bonding agent comprises an epoxy adhesive capable of accommodating movement within the bore pit.

17. The system of claim 15, further comprising:
a joint seal for providing a fluid impervious seal across a joint between the side walls and the lower barrier.

18. The system of claim 17, wherein the width of the joint seal extending from the side walls across the lower barrier is on the order of ten inches.

19. The system of claim 18, wherein the joint seal comprises a spray-applied polyurethane material.

20. The system of claim 15, further comprising:
at least one support for supporting the pipeline above the lower barrier.

21. The system of claim 15, further comprising:
backfill adapted for positioning at least one of around and above the pipeline, the backfill permitting fluid within the bore pit to propagate through interstitial regions therebetween.

22. The system of claim 15, further comprising:
an upper barrier extending across the side walls and above the backfill, the upper barrier for preventing fluid from exiting or entering the bore pit.

23. A method of creating a containment system adapted for containing at least a predetermined volume of fluid released from a pipeline disposed therein, the method comprising the steps of:
excavating a trench in a ground area for housing at least a portion of the containment system;
positioning a centralizer ring around the pipeline;
placing a leak detection system substantially contacting the pipeline for determining if a leak from the pipeline has occurred;
placing a galvanic anode ribbon substantially contacting the pipeline for aiding in cathodic protection;
encasing the pipeline with a spill containment pipe for capturing a leak from a pipeline; and
placing the encased pipeline within the excavated trench.

24. The method of claim 23, wherein the step of placing a leak detection system comprises:
placing a leak detection power conduit at an upper portion of the pipeline; and
placing a leak detection well screen conduit at an upper portion of the pipeline.

25. The method of claim 23, further comprising the step of:
forming a bore pit, the bore pit being an enlarged subsurface containment area.

26. The method of claim 25, further comprising the step of:
directing leaked fluid through the spill containment pipe into the bore pit.
